(19) United States
(12) Patent Application Publication
(10) Pub. No.: US 2006/0115016 A1
(43) Pub. Date: Jun. 1, 2006

(54) Methods and apparatus for transmitting and receiving data signals

(75) Inventors: Lin Chen, Cupertino, CA (US); Sam Huynh, Mountain View, CA (US); Joe Macri, San Francisco, CA (US)

Correspondence Address: ATI TECHNOLOGIES, INC.;C/O VEDDER PRICE KAUFMAN & KAMMHOLZ, P.C., 222 N.LASALLE STREET, CHICAGO, IL, 60601, US

(73) Assignee: ATI Technologies Inc., Markham (CA)

(21) Appl. No.: 10/987,747

(22) Filed: Nov. 12, 2004

(51) Int. Cl. H04L 27/20

(52) U.S. Cl. 375/295; 345/530; 345/501

(57) ABSTRACT

Methods and apparatus for transmitting and receiving data in a memory interface are disclosed. The apparatus include a programmable transceiver having a variable duty cycle control, with the transceiver having at least one of a programmable variable duty cycle receiver and a programmable variable duty cycle transmitter. The receiver and the transmitter are both responsive to variable duty cycle control data and operate to vary a duty cycle of one of incoming and outgoing data. By providing programmability to the data duty cycle, the transceiver can optimally accommodate different memory device standards.

### BACKGROUND OF THE INVENTION

The present disclosure relates generally to methods and apparatus for transmitting and receiving data signals, and more particularly to methods and circuits for varying a duty cycle of signals being transmitted and received in a memory interface. Given the event of higher speed memory interfaces, such as double data rate (DDR), a number of differing standards have arisen for the different types of DDR interfaces (e.g., DDR 1, DDR 2 and GDDR 3 SDRAM memories). Additionally, the current trend for DDR interfaces is to push the operating frequencies higher. As an example, 500 MHz GDDR3 DRAMs are currently available and soon 1 GHz DRAMS will be available. Thus, in order to meet such high frequency requirements, data transceivers for sending and receiving data within a memory interface have become difficult to design. This difficulty is compounded by the existence of the disparate DDR interface standards.

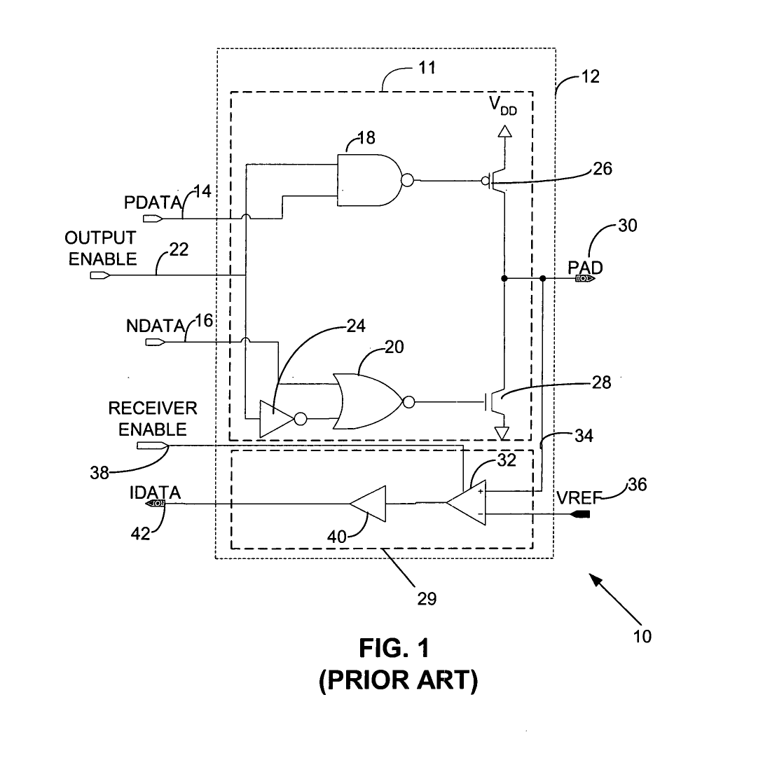

A conventional design for a circuit used for transmitting and receiving data with memory interfaces is illustrated in FIG. 1. As shown, the circuit 10, includes a transceiver 12, that receives data PDATA and NDATA to be transmitted and data to be received (i.e., IDATA). A transmitter portion 11 of the transceiver 12 includes data input lines 14 and 16 that respectively receive PMOS data (IDATA) and NMOS data (NDATA). These data are respectively delivered to logic gates 18 and 20; the PMOS data (PDATA) being fed to a NAND gate and the NMOS data (NDATA) being fed to a NOR gate. An Output Enable signal 22 is input to each of the gates 18 and 20 via a suitable input line or bus in order to enable the output of the PDATA and NDATA through the logic gates 18 and 20. The Output Enable signal delivered to the NOR gate also is inverted by inverter 24 such that the logic gates 18 and 20 are operated alternately dependent on the high or low state of the Output Enable signal.

The outputs of NAND gate and NOR gate are respectively delivered to a serially coupled PMOS transistor 26 and an NMOS transistor 28 in order to switch these devices on and off to transmit data via PAD 30 connected between these transistors. The logic gates 18 and 20 output binary states that cause either of transistors 26 or 28 to conduct the desired high or low data signals output from PAD 30 over the memory interface.

In the receiver portion 29 of transceiver 12, a data signal input to the transceiver 12 is received via PAD 30 and fed to a differential comparator 32 via line 34. The differential comparator 32 compares the incoming data signal on line 34 to a voltage reference threshold 36 where the comparator 32 outputs a high signal when the data on line 34 exceeds the voltage reference threshold 36, or outputs a low signal when the data on line 34 is lower than the voltage reference threshold 36. Additionally, the differential comparator 32 receives an enable signal via line 38 that first enables the receiver portion of the transceiver 12 to receive data. The output of the differential comparator 32 is fed to a buffer 40 that is used to control the timing or level shifting of the data sent to input data (IDATA) connection 42.

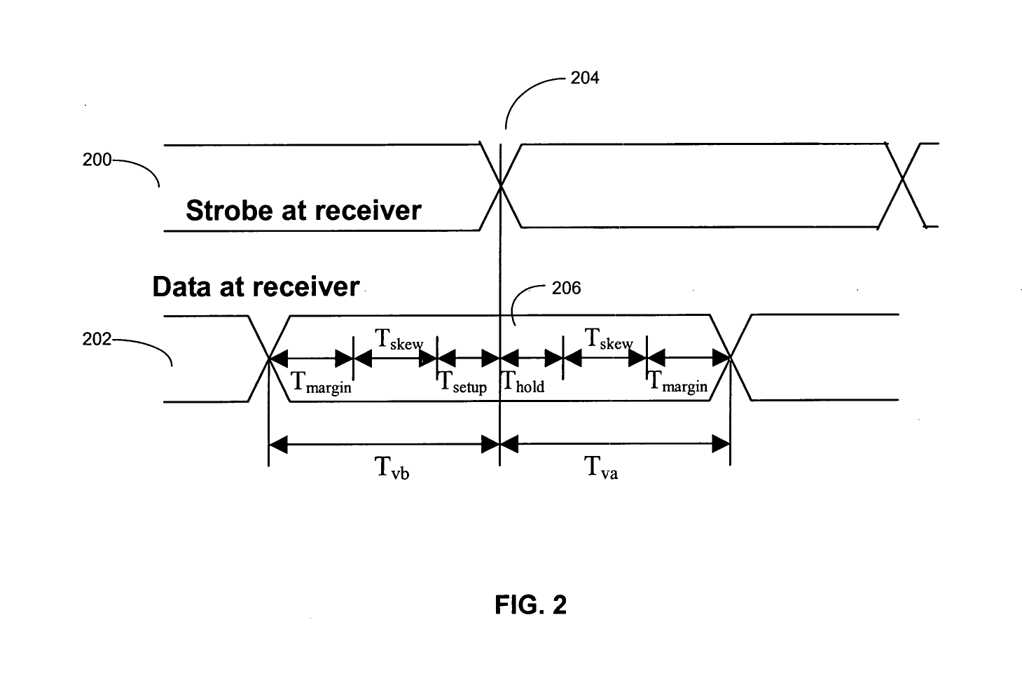

In memory interfaces employing transceivers such as transceiver 12 illustrated in FIG. 1, it is important that the timing margins are optimal. By way of illustration, FIG. 2 illustrates a DDR interface timing diagram showing timing for a receiver portion of a transceiver such as transceiver 12. In particular, FIG. 2 illustrates the strobe or clock signal 200 at the receiver. Additionally, FIG. 2 illustrates a data signal at the input of the receiver 29. In this figure, the strobe is shown centered, as indicated by line 204, in the data valid window 206 of the data, which achieves optimum timing margins at the beginning and end of the data window for both the set up (T_{set up}) and data hold (T_{hold}). It is desirable to ensure that the timing margins (T_{margin}) are optimized to be positive in order for the interface to work properly after minimizing the skew time (T_{skew}), which is caused by process, voltage and temperature variations, as well as board mismatch between different chips and reduces the timing margins. As the frequency requirements increase, designing transceivers becomes more difficult because the time of the data valid window is less. In order to operate at over 500 MHz, for example, the duty cycle needs to be essentially 50/50 for new DDRs such that the data valid window 206 is maximized for such frequencies.

Additionally, typical computer systems employ several chips that are designed by different designers or companies. Accordingly, although there may be industry standards to define how the interfaces should work, due to the difficulty of circuit design, as well as process, voltage, and temperature variables causing duty cycle gate shifting, the combination of non-ideal duty cycles of different transceivers may ultimately cause system failures.

Another complicating factor is that designs must support multiple DDR interface standards. These different interfaces standards, however, have different signaling protocols that lead to different swing levels and different symmetrical levels. As an example, DDR1 requires signals to have good duty cycles at half of a normal power supply, whereas GDDR3 needs signals with good duty cycles at seventy percent of a normal power supply voltage.

It has been contemplated that to account for different DDR interface standards, while still utilizing the same PADs, different transceivers designed for the different standards may be employed and then the outputs are selectively multiplexed dependent on the particular standard utilized. Another approach is to simply optimize one transceiver designed for one standard and then simply compromise on the other DDR interface standards that may be used. This approach, however, requires too much of an area demand on an integrated circuit, thus not being cost efficient, and not compatible across the different standards.

### DETAILED DESCRIPTION OF THE DRAWINGS

FIG. 1 illustrates an example of a conventional transceiver circuit.

FIG. 2 is a timing diagram illustrating strobe (clock) and data signals at a receiver.

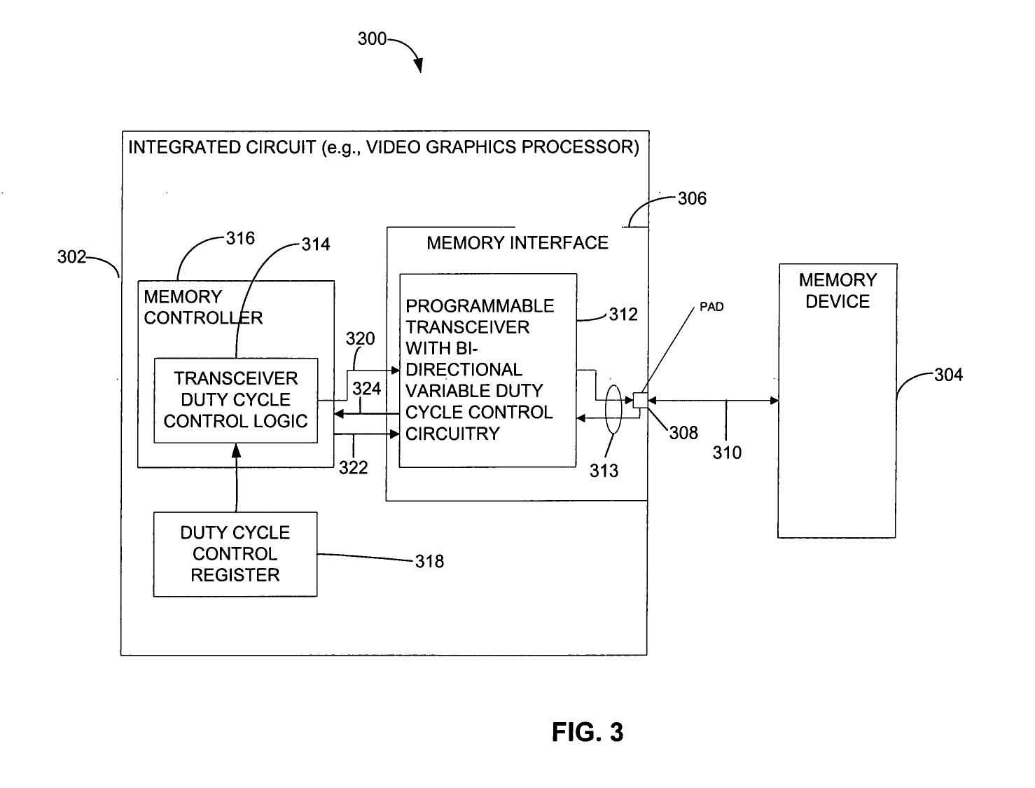

FIG. 3 illustrates an example of a system employing a programmable transceiver in accordance with the present disclosure.

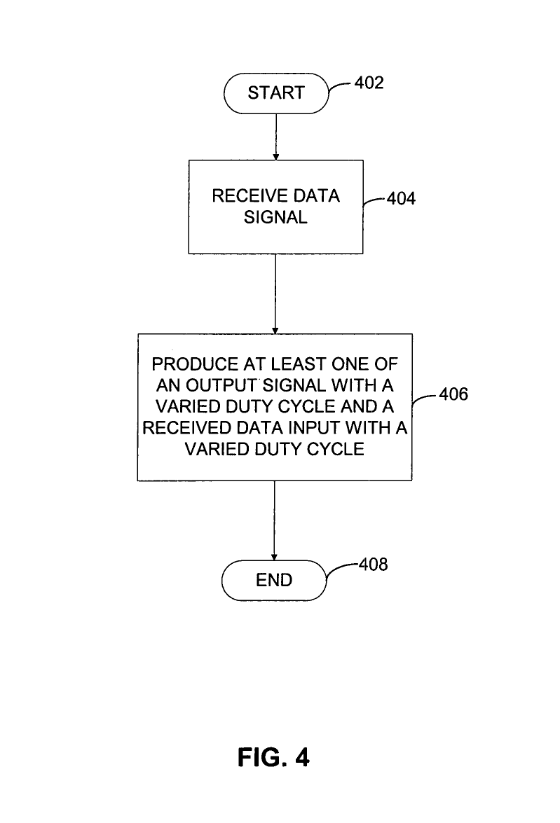

FIG. 4 is a flowchart illustrating one example of a method for receiving and transmitting data in a memory interface in accordance with one embodiment of the disclosure.

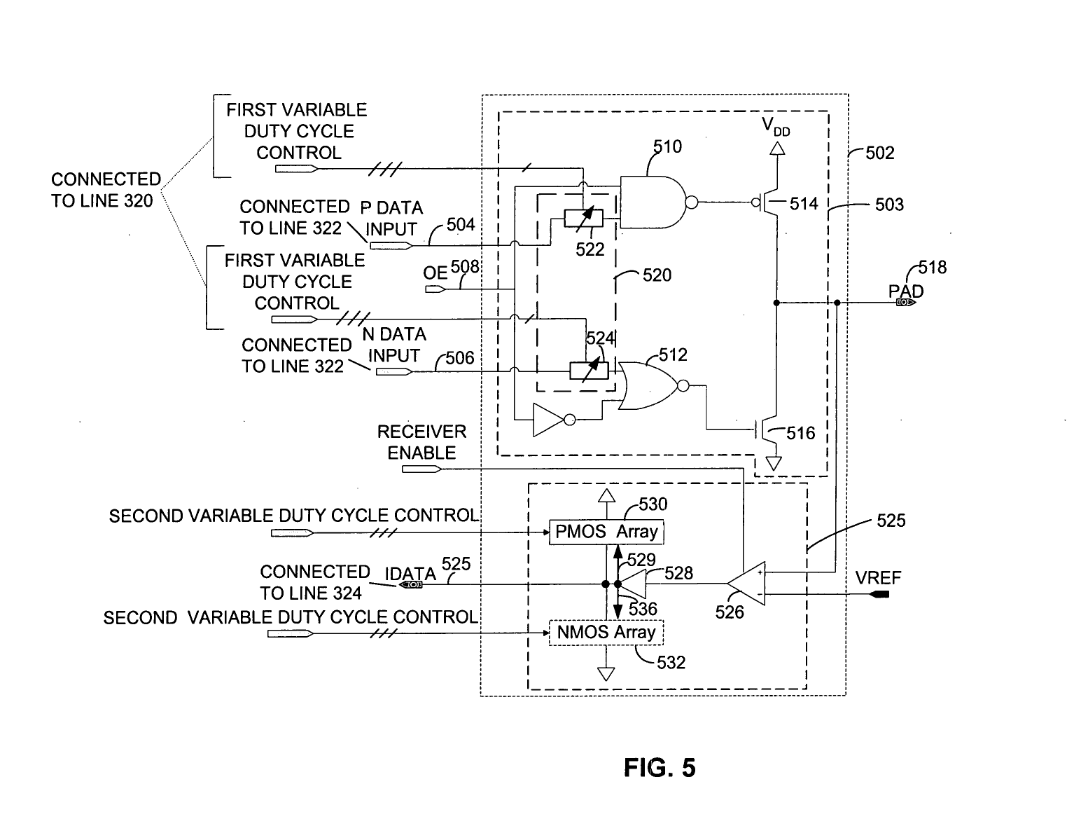

FIG. 5 is a circuit diagram of one example of a programmable transceiver in accordance with the present disclosure.

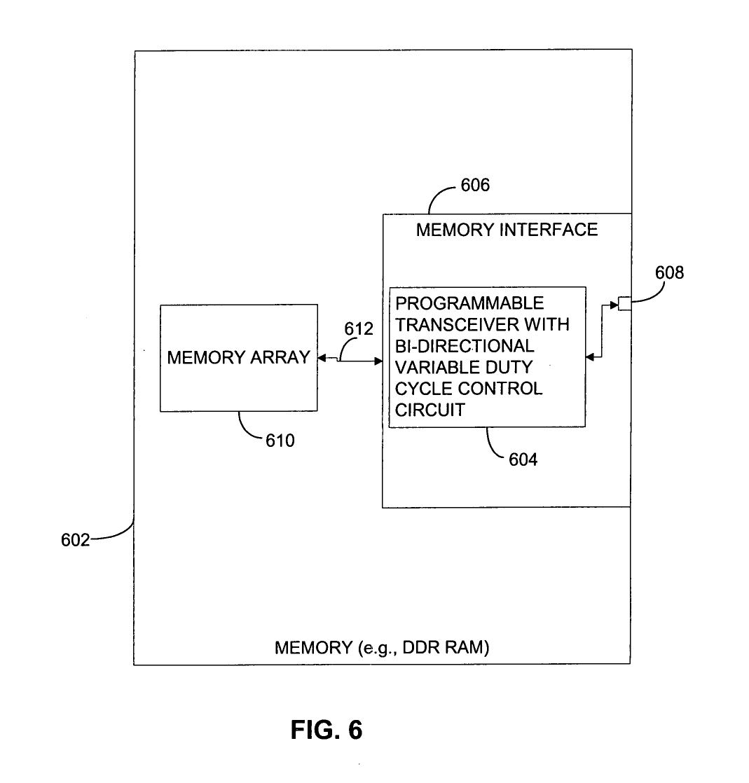

FIG. 6 is a block diagram illustrating another example of a programmable transceiver used in a memory interface inside a memory device in accordance with the present disclosure.

### DETAILED DESCRIPTION OF THE PRESENT EMBODIMENTS

The present disclosure describes a transceiver used, for example, in a memory interface that includes variable duty cycle control in order to vary at least one of incoming and outgoing data in a respective receiver or transmitter. In particular, the present disclosure relates to a programmable transceiver with variable duty cycle control. The programmable transceiver is configured having at least one of a programmable variable duty cycle receiver and a programmable variable duty cycle transmitter, each responsive to variable duty cycle control data and operable to vary a duty cycle of at least one of incoming data and outgoing data. Such a transceiver affords setting of a duty cycle close to an ideal duty cycle given a particular DDR interface standard and also allows compensation due to process, voltage and temperature variations. Accordingly, the interface may better optimize the data valid window for signaling, thereby achieving higher performance or yield compared to more conventional transceiver designs.

FIG. 3 illustrates an integrated circuit 302 such as a video graphics processor or any other suitable processor or circuit that writes data to and reads data from a memory device 304. The integrated circuit 302 includes a memory interface 306 that effects data signaling between the integrated circuit 302 and memory device 304 and pad 308 on data and control bus 310 or any suitable bus. The memory interface 306 includes a programmable transceiver 312 that is operably coupled to the pad 308 via bus 313. The transceiver 312 features a functionality of bi-directional duty cycle control circuitry [antecedent]. This circuitry allows the receiving and transmitting portions of the programmable transceiver 312 to be responsive to variable duty cycle control data received from transceiver duty cycle control logic 314 within a memory controller 316 in order to vary the duty cycle of either incoming or outgoing data from memory interface 306. The transceiver duty cycle control logic 314 may also be configured to receive or read the variable duty cycle control data from a duty cycle control register 318.

Additionally, the programmable transceiver 312 receives the control data 320 from the duty cycle control logic 314. The memory controller 316 sends data 322 to the programmable transceiver 312 via a suitable bus or other link. Similarly, the programmable transceiver 312 sends received data 324 received through the pad 308 to the memory controller 316.

Operation of the integrated circuit of FIG. 3 is described in connection with the flow chart illustrated in FIG. 4. After an initialization 402, the programmable transceiver 312 may receive data 322, as shown at block 404 from either the memory controller 316 via line 322 or data from the memory interface; namely from pad 308. The programmable transceiver 312 produces either an output signal with a varied duty cycle to be sent out, in this example, to the memory device 304 via pad 308 and data bus 310 or produce received data with a varied duty cycle that is subsequently transmitted from the programmable transceiver 302 to the memory controller 316 via bus 324. Block 406 in FIG. 4 illustrates this operation. The process then ends at block 408 by the memory interface waiting for another communication.

FIG. 5 illustrates an exemplary circuit layout for the programmable transceiver 312 shown in FIG. 3. As shown in FIG. 5, the transceiver 502 contains similar structural elements to the conventional transceiver previously described with respect to FIG. 1. Namely, the transceiver 502 includes a transmitter portion 503 that receives PMOS data and NMOS data inputs via lines 504 and 506, respectively. Additionally, an Output Enable signal from the memory controller 316 enables transmission of the data inputs. Moreover, FIG. 5 illustrates similar NAND and NOR dates 510 and 512, respectively, which drive PMOS transistor 514 and NMOS transistor 516, respectively, to produce data output signals on pad 518. It is noted that the NAND and NOR gates 510 and 512 in the transmitting path may be incorporated together in order to minimize cross-bar current in order to lessen power dissipation.

For the purposes of achieving programmable duty cycle control, FIG. 5 also features an array 520 of time delay lines between the data inputs 504 and 506 and the NAND and NOR gates 510 and 512, respectively. As illustrated, the array 520 may include a least two variable or adjustable time delay lines 522 and 524. These programmable time delay lines may be implemented using any devices such as PMOS or NMOS transistors, or poly or metal wires. Each of the time delay lines 522 and 524 are configured to receive duty cycle control data from the first variable duty cycle control. These input logic bits are received via control bus 320 illustrated in FIG. 3 from the transceiver duty cycle control logic 314 and the memory controller 316. The duty cycle control register 318 shown in FIG. 3 may control the first variable duty cycle control data. The number bits for each of the incoming duty cycle controls to the delay lines 522 and 524 depend on the degree of adjustment resolution desired. In the present example, two or three bits are sufficient control to effectively adjust the duty cycle. Thus, as the time delays within the delayed lanes 522 and 524 are varied, this delay adjusts the turn on and turn off times of the PMOS and NMOS transistors 514 and 516, which in turn, adjust the duty cycle of the data output at the pad 518 the finer the resolution of the delay lines 522 and 524, the better the duty cycle adjustment will be.

As an example of the operation of the transmitter portion 503, if the signal output at the pad 518 has a longer HIGH time (e.g., binary “1”) then LOW time (e.g., binary “0”), the PMOS transistor 514 is switching faster than the NMOS transistor 516. Accordingly, with the delay line 522, the PDATA input path (i.e., input line 504 and time delay 522) can be delayed in order to slow down the switching of the PMOS transistor 514. Similarly, the time delay line 524 can be used to delay the end data path if the NMOS transistor 516 needs to be switched slower. It is noted that, depending on the different memory interface standards, sometimes only the first variable duty cycle control data need be sent to time delay line 522. Similarly, sometimes only control of the time delay line 524 by the first variable duty cycle control data is needed.

The transceiver 502 also includes variable duty cycle control in a receiver portion 525 of this device. Because the receiver input path is only a single path, however, the use of delay lines, such as those used in the transmitter portion, are not as desirable for adjusting the duty cycle of the input data (IDATA) incoming via the receiver portion of the transceiver 502. Rather, the transceiver 502 utilizes adjustment of the ratio of PMOS logic to NMOS logic within the receiver to vary the outgoing data 525.

Concerning the receiver portion of the transceiver 502, in particular, the data received via pad 518 is fed to differential amplifier 526, which compares the incoming data with a voltage reference threshold (VREF), similar to the conventional transceiver illustrated in FIG. 1. The particular setting of the threshold voltage VREF is determined based on the particular memory interface standard being supported.

As shown in FIG. 5, the output of the differential comparator 526 is delivered to a buffer 528, which serves to effect the time delay of the data from the comparator 526. As illustrated, sets or arrays of particular types of transistor logic are connected on the output side of the buffer 528. In particular, a PMOS array of transistors 530 and an NMOS array 532 are connected to the output of the buffer 528 via lines 534 and 536, respectively. The arrays 530 and 532 are connected, as an example, between a potential (V_{DD}) and a common ground potential. Each of the transistor arrays 530 and 532 receive second variable duty cycle control data from the duty cycle control register 318 via the transceiver duty cycle control logic 314 and bus 320. Similar to the delay lines 522 and 524, typically the control data having either two or three bits is sufficient to achieve good adjustment resolution. In the particular PMOS and NMOS arrays 530 and 532, the second variable duty cycle control signal controls the number of transistors in the arrays 530 and 532 that are added electrically parallel to the buffer 528. Thus, as PMOS or NMOS transistors are connected and parallel to buffer 528, the PMOS to NMOS ratio is varied, which modifies or adjusts the buffer 528 rising and falling delay times and slew rates. This adjustment achieves variation of the duty cycle for the outgoing data via IDATA 525.

Additionally, as indicated by the dashed line around the NMOS array 532, this array is not needed for certain interface standards being supported. Alternatively, the particular data in the second variable duty cycle control data can be delivered to only one of the arrays 530 or 532 depending on the particular memory interface standard.

It is noted that because the duty cycle adjustments in both the transmitter and receiver portions of the transceiver 502 are controlled by the duty cycle control register 318, this approach is a digital duty cycle controlled scheme. Additionally, the duty cycle control register 318 shown in FIG. 3 may be writeable registers in order to afford the ability to write different information in the register settings to accommodate for variations for such as process, voltage and temperature in other factors in order to optimize the duty cycles of the transceivers.

FIG. 6 illustrates another example where a programmable transceiver having bi-directional variable duty cycle control may be utilized within a memory chip such as a DDR SDRAM. In particular, a memory 602 is illustrated having a programmable transceiver circuit 604 located within the memory interface 606 of the memory 602. The memory interface reads and writes data to and from any device accessing the memory via pads, such as pad 608 illustrated in FIG. 606. The memory interface 608 accesses the memory array 610 via internal bus architecture 612 within the memory 602. The programmable transceiver circuit 604 may be of the construction illustrated and described in FIG. 5.

The disclosed transceiver circuit, such as those illustrated in FIGS. 3, 5 and 6, is useful for compensation of duty cycle distortion due to the transceiver design of another party or chip on the other side of the interface in which the transceiver is located. Additionally, the disclosed transceiver is adjustable such that the transceiver accommodates process, voltage, and temperature variations and accommodates multiple DDR standards. The transceiver design disclosed is simple from a design approach, which affords minimum or no impact on a chip build out in which the transceiver is used.

Referring back to FIG. 3, it is also noted that the data within a duty cycle control register 318 may be either static or dynamic. In the case of static data in register 318, the settings of these registers could, for example, be set by the basic internal operating system (BIOS) upon initialization of the chip or system in which the register is located and these settings are not changed after the initialization. The actual settings of the control data, [ref. #s ] such as the first variable duty cycle control data and second variable duty cycle control data could be optimized settings that are obtained previously from some statistically significant sampling.

Alternatively, the dynamic approach allows the settings of register 318 to be changed after the initial BIOS settings. These settings may be changed during system power up or idle states so that the system operations are not affected by changing the settings. Dynamic updates to the register settings can be based on a system training, which is a BIOS or software based optimization process where the register settings are exhaustively set and the system behavior and performance are monitored by a set of benchmarks. Based on these benchmark results, optimized settings of the registers may be chosen and set by the BIOS or software. Although the dynamic approach is more complicated than the static approach and utilizes more system resources, this approach nonetheless gives the best performance for duty cycle control.

The above-disclosed transceiver affords setting of a duty cycle close to an ideal duty cycle given a particular DDR interface standard and also allows for compensation due to process, voltage and temperature variations. Accordingly, the interface may better optimize the data valid window for signaling, thereby achieving higher performance or yield compared to more conventional transceiver designs. It will be recognized by those skilled in the art that the above-described programmable transceiver may be programmed to vary the duty cycle from a 50/50 duty cycle, to whatever duty cycle is desired to have better system performance.

The above detailed description and examples have been presented for the purposes of illustration and description only and not by limitation. It is therefore contemplated that the present disclosure covers any and all modifications, variations or equivalents that fall within the spirit and scope of the appended claims.

What is claimed is:

1. A memory interface circuit comprising:
at least one programmable transceiver with variable duty cycle control, having at least one of a programmable variable duty cycle receiver and a programmable variable duty cycle transmitter, each responsive to variable duty cycle control data and operable to vary a duty cycle of at least one of incoming data and outgoing data.

2. The memory interface circuit as defined in claim 1, wherein the programmable variable duty cycle receiver includes at least one transistor network configured to adjust a ratio of a first transistor type to a second transistor type within the network based on the variable duty cycle control data.

3. The memory interface circuit as defined in claim 2, wherein the first transistor type is PMOS and the second transistor type is NMOS.

4. The memory interface circuit as defined in claim 1, wherein the programmable variable duty cycle transmitter includes first and second data paths each having an adjustable delay line responsive to the variable duty cycle control data.

5. The memory interface circuit as defined in claim 3, wherein the adjustable delay lines are configured to delay the input data signals by predetermined time delay amounts that are based on a selected memory device standard.

6. An integrated circuit comprising:
a memory array; and
a memory interface operably coupled to the memory array, the interface including:
at least one programmable transceiver with variable duty cycle control, having at least one of a programmable variable duty cycle receiver and a programmable variable duty cycle transmitter, each responsive to variable duty cycle control data and operable to vary a duty cycle of at least one of incoming data and outgoing data.

7. The integrated circuit as defined in claim 6, wherein the programmable variable duty cycle receiver includes at least one transistor network configured to adjust a ratio of a first transistor type to a second transistor type within the network based on the variable duty cycle control data.

8. The integrated circuit as defined in claim 6, wherein the programmable variable duty cycle transmitter includes first and second data paths each having an adjustable delay line responsive to the variable duty cycle control data.

9. A video graphics processor comprising:
a memory interface having a programmable transceiver with bi-directional variable duty cycle control including:
a programmable variable duty cycle transmitter, operative to transmit at least a first data signal, having at least one logic gate configured to switch states based on the first data signal and at least one adjustable delay line connected to the at least one logic gate configured to adjust the duty cycle of the first data signal; and
a programmable variable duty cycle receiver, having an input for receiving a second data signal, a differential comparator configured to compare received data from the input with a predetermined threshold, and at least a first transistor array connected to an output of the comparator and configured to adjust a duty cycle of the second data signal by varying a number of a first type of transistors operating in the first transistor array.

10. The video graphics processor as defined in claim 9, wherein the first type of transistors are one of PMOS and NMOS transistors.

11. The video graphics processor as defined in claim 9, further comprising:
a second transistor array connected to the output of the comparator and capable of further adjusting the duty cycle of the second data signal by a change in a number of a second type of transistors operating in the second array.

12. The video graphics processor as defined in claim 11, wherein the second type of transistors are one of PMOS and NMOS transistors.

13. The video graphics processor as defined in claim 9, wherein the predetermined threshold is set based on a particular memory standard.

14. The video graphics processor as defined in claim 9, wherein the adjustable time delay line is configured to delay the first data signal by a time delay amount that is based on a memory standard.

15. The video graphics processor as defined in claim 9, further comprising:
a memory controller configured to monitor performance of the memory interface and dynamically control settings of the delay line control register and the transistor array control register in response to the monitored performance.

16. A method for transmitting data signals in a memory interface comprising:
delaying transmission of one or more data signals to be transmitted in the memory interface using at least one adjustable delay line to adjust output timing of a data crossing point of the data signals; and
transmitting the one or more data signals within the memory interface.

17. The method as defined in claim 16, wherein the adjustable time delay line is configured to delay the input data signals by a time delay amount that is based on a memory standard.

18. A method for receiving data signals in a memory interface comprising:
receiving at least one data signal;
comparing the received at least one data signal with a predetermined threshold using a differential comparator;
adjusting a duty cycle of the received at least one data signal using a first transistor array connected to an output of the comparator by changing a number of a first type of transistors operating in the first array.

19. The method as defined in claim 18, wherein the first type of transistors are one of PMOS and NMOS transistors.

20. The method as defined in claim 18, further comprising:
adjusting the duty cycle of the received at least one data signal by further changing a number of a second type of transistors operating in a second array of transistors.

21. The method as defined in claim 20, wherein the second type of transistors are one of PMOS and NMOS transistors.
